(19) United States
(12) Patent Application Publication
(10) Pub. No.: US 2025/0240341 A1
(43) Pub. Date: Jul. 24, 2025

(54) METHOD FOR TRANSMITTING FILE, TERMINAL DEVICE AND STORAGE MEDIUM

(71) Applicant: SHENZHEN ZOLON TECHNOLOGY CO., LTD., Shenzhen (CN)

(72) Inventors: XIULIANG CHEN, Shenzhen (CN); ZIANG ZHAO, Shenzhen (CN)

(21) Appl. No.: 18/849,127

(22) PCT Filed: Mar. 21, 2023
(86) PCT No.: PCT/CN2023/082847

§ 371 Date: Sep. 20, 2024

(30) Foreign Application Priority Data
Apr. 7, 2022 (CN) 202210361593.9

(51) Int. Cl. H04L 67/06; G06F 16/182; H04L 69/22

(52) U.S. Cl. CPC H04L 67/06; G06F 16/183; H04L 69/22

(57) ABSTRACT

The present application is applicable to a technical field of data transmission, and provides a method for transmitting file, a terminal device, and a storage medium. The method including: acquiring a plurality of communication ways; transmitting file contents of a file to be transmitted to a receiving device in parallel, by using the plurality of communication ways. The present application can improve the file transmissions efficiency, such that a file transmissions speed is increased, and a transmission time is shortened.

This application claims a priority of a Chinese Patent Application with an application number 202210361593.9 filed with the China National Intellectual Property Administration on Apr. 7, 2022, the entire contents of which are incorporated by reference in the present application.

### FIELD

The present application belongs to a field of data transmission technology, and in particular relates to a method for transmitting file, a terminal device and a storage medium.

### BACKGROUND

With a development of information age and advancement of technology, data is growing explosively. Not only data amount increasing, but also a size of a single file is increasing. For example, a size of an image increases from a few kilobytes to tens of megabytes, a size of a song increases from hundreds of kilobytes to tens of megabytes, and a size of a video increases from a few megabytes to tens of gigabytes.

Larger files carry more information, thereby providing users a better experience for using files, but also face greater challenges as file transmissions. Limited by transmission speeds of communication ways between terminal devices, users have to wait for long time when transmitting files between different terminal devices, resulting in a degraded user experience.

In summary, there is an urgent need for providing a method that can transmit files quickly to improve transmission speed of files and reduce file transmissions time.

### SUMMARY

### Technical Problem

In view of this, embodiments of the present application provide a method for transmitting file, a terminal device and a storage medium, the embodiments can solve a problem that file transmissions time is too long in the prior art.

### Technical Solutions

In a first aspect, the embodiments of the present application provide a method for transmitting file, applied in a transmitting device, the method including:
acquiring a plurality of communication ways;
transmitting file contents of a file to be transmitted to a receiving device in parallel, by using the plurality of communication ways.

In a first possible implementation manner of the first aspect, acquiring the plurality of communication ways, including:
acquiring communication ways that are available to perform file transmissions with the receiving device;
determining the plurality of communication ways from the communication ways that are available to perform the file transmissions with the receiving device.

In a second possible implementation manner of the first aspect, determining the plurality of communication ways from the communication ways that are available to perform the file transmissions with the receiving device, including:
acquiring file size of the file to be transmitted, and determining the plurality of communication ways from the communication ways that are available to perform the file transmissions with the receiving device, according to the file size; or
acquiring the file size and a file number of the file to be transmitted, and determining the plurality of communication ways from the communication ways that are available to perform the file transmissions with the receiving device, according to the file size and the file number; or
acquiring a transmission speed and a transmission stability of each of the communication ways that are available to perform the file transmissions with the receiving device, and determining the plurality of communication ways from the communication ways that are available to perform the file transmissions with the receiving device, according to the transmission speed and the transmission stability.

In a third possible implementation manner of the first aspect, before determining the plurality of communication ways from the communication ways that are available to perform the file transmissions with the receiving device, further including:
acquiring a usage status of each communication way applied in the transmitting device, among the communication ways that are available to perform the file transmissions with the receiving device;
filtering the communication ways that are available to perform the file transmissions with the receiving device, according to the usage status of the each communication way, and performing an operation of determining the plurality of communication ways from the communication ways that are available to perform the file transmissions with the receiving device, based on remaining communication ways after filtering.

In a fourth possible implementation manner of the first aspect, transmitting the file contents of the file to be transmitted to the receiving device in parallel, by using the plurality of communication ways, including:
determining one or more starting position points in the file to be transmitted, and determining a starting position point corresponding to each communication way of the plurality of communication ways;
controlling each communication way of the plurality of communication ways, starting from a corresponding starting position point, to transmit the file contents of the file to be transmitted to the receiving device in parallel.

In a fifth possible implementation manner of the first aspect, transmitting the file contents of the file to be transmitted to the receiving device in parallel, by using the plurality of communication ways further, including:
acquiring transmission workload of each communication way of the plurality of communication ways;
during a process of transmitting the file contents of the file to be transmitted to the receiving device in parallel, by using the plurality of communication ways, includes:
if there are communication ways among the plurality of communication ways have completed the corresponding transmission workload before finishing transmitting the file to be transmitted, transmitting file contents, which have not been transmitted, of the file to be transmitted in parallel by using the communication ways that have completed the corresponding transmission workload.

In a sixth possible implementation manner of the first aspect, the plurality of communication ways include a first communication way and a second communication way; there are two starting position points, which include a file header and an end of the file to be transmitted; the first communication way corresponds to the file header, and the second communication way corresponds to the end of the file;
controlling each communication way of the plurality of communication ways, starting from the corresponding starting position point, to transmit the file contents of the file to be transmitted to the receiving device in parallel, including:
controlling the first communication way to start from the file header, and controlling the second communication way to start from the end of the file to be transmitted, to transmit the file contents of the file to be transmitted to the receiving device in parallel.

In a second aspect, the embodiments of the present application provide a device for transmitting file, the device for transmitting file including:
a communication acquisition module, the communication acquisition module is configured to acquire a plurality of communication ways;
a parallel transmission module, the parallel transmission module is configured to transmit file contents of a file to be transmitted to a receiving device in parallel, by using the plurality of communication ways.

In a third aspect, the embodiments of the present application provide a terminal device, which includes a storage device, a processor, and computer programs stored in the storage device and operable on the processor, when the processor executes the computer programs, a method for transmitting file according to any one of the first aspect is implemented.

In a fourth aspect, the embodiments of the present application provide a computer-readable storage medium, the computer-readable storage medium storing computer programs, when the computer program is executed by a processor, a method for transmitting file according to any one of the first aspect is implemented.

In a fifth aspect, the embodiments of the present application provide a computer program product, which enables a terminal device to execute a method for transmitting file described in any one of the first aspect when the computer program product is run on the terminal device.

In a sixth aspect, the embodiments of the present application provide a chip system, the chip system includes a processor, the processor is coupled to a storage device, and when the processor executes computer programs stored in the storage device, a method for transmitting file according to any one of the first aspect is implemented.

The chip system may be a single chip or a chip module composed of a plurality of chips.

It can be understood that, beneficial effects of the second aspect to the sixth aspect can be referred to relevant description in above-mentioned first aspect, it is not repeated here.

### Beneficial Effects

Compared with the prior art, the embodiments of the present application have following beneficial effects: the embodiments of the present application simultaneously utilize the plurality of communication ways supported by a transmitting device and a receiving device to transmit the file contents of the file to be transmitted in parallel. By utilizing the plurality of communication ways for transmitting file at a same time, an efficiency of transmitting file can be improved, resulting in faster file transmissions speeds and reduced transmission time. A user experience of transmitting file can be improved.

### BRIEF DESCRIPTION OF THE DRAWINGS

In order to more clearly illustrate technical solutions in the embodiments of the present application, drawings that need to be used in the descriptions of the embodiments or the prior art will be briefly introduced below. Obviously, the drawings in the following description are merely some examples of the present application, those of ordinary skill in the art can also obtain other drawings based on the drawings without paying creative efforts.

FIG. 1 is a schematic flowchart of a method for transmitting file provided by an embodiment of the present application;

FIG. 2 is a schematic flowchart of a method for transmitting file provided by an embodiment of the present application;

FIG. 3 is a schematic flowchart of a method for transmitting file provided by an embodiment of the present application;

FIG. 4 is a schematic flowchart of a method for transmitting file provided by an embodiment of the present application;

FIG. 5 is a schematic flowchart of a method for transmitting file provided by an embodiment of the present application;

FIG. 6 is a schematic diagram of the application scenario of the starting position point provided by an embodiment of the present application;

FIG. 7 is a schematic diagram of the application scenario of the starting position point provided by an embodiment of the present application;

FIG. 8 is a schematic flowchart of a method for transmitting file provided by an embodiment of the present application;

FIG. 9 is a schematic flowchart of a method for transmitting file provided by an embodiment of the present application;

FIG. 10 is a schematic diagram of an application scenario of transmitting file provided by an embodiment of the present application;

FIG. 11 is a schematic flowchart of transmitting file contents through communication ways provided by an embodiment of the present application;

FIG. 12 is a system interaction diagram of a method for transmitting file provided by an embodiment of the present application;

FIG. 13 is a schematic structural diagram of a device for transmitting file provided by an embodiment of the present application;

FIG. 14 is a schematic structural diagram of a terminal device provided by an embodiment of the present application.

### DESCRIPTION

In following descriptions, specific details such as specific system structures and technologies are presented for a purpose of illustration rather than limitation, so as to thoroughly understand the embodiments of the present application. However, it should be clear to those skilled in the art that the present application can be implemented in other embodiments without these specific details. In other cases, detailed descriptions of well-known systems, devices, circuits, and methods are omitted to avoid unnecessary details that may hinder description of the present application.

First, it should be noted that in the embodiments of the present application, a transmitting device and a receiving device are two different terminal devices. The transmitting device refers to a terminal device that sends files, and the receiving device refers to a terminal device that receives files. Since a single terminal device may need to send files or receive files in different application scenarios. Therefore, in actual applications, the transmitting device and the receiving device are only named to differentiate terminal device(s) in a single scenario, and do not constitute a limitation on the terminal device.

In some embodiments of the present application, a file that needs to be transmitted can be called as a file to be transmitted.

In addition, in the embodiments of the present application, “a plurality of” means two or more.

The method for transmitting file provided by the embodiments of the present application can be applied to a terminal device such as mobile phones, computers, tablets, and wearable devices. At this time, the terminal device is an execution device of the method for transmitting file provided by the embodiments of the present application. The embodiments of the present application do not restrictions on a specific type of the terminal device.

In order to realize file transmissions between different terminal devices, communication ways such as Wi-Fi, a cellular network, BLUETOOTH or wired connection can be used to transmit files. However, no matter which communication way is used, its transmission capacity is relatively limited. Therefore, in actual applications, it is easy to be limited by a transmission speed of a selected communication way, resulting in slow file transmissions speed and poor user experience.

In actual applications, it is found that the terminal device often supports more than one communication way. For example, the terminal device, such as smartphones, tablets, and laptops often support two or more communication ways. Such as common Wi-Fi, BLUETOOTH, the cellular network, Near Field Communication (NFC), data cable, wired broadband and other communication ways.

Based on the above actual situation, in order to improve the file transmissions speed, the embodiment of the present application provides a method for transmitting file. When transmitting a file between terminal devices, this embodiment of the present application utilizes the plurality of communication ways supported by the transmitting device and the receiving device to transmit the file contents of the file to be transmitted in parallel. By utilizing the plurality of communication ways for transmitting file at a same time, an efficiency of transmitting file can be improved, resulting in faster file transmissions speeds and reduced transmission time. A user experience of transmitting file can be improved.

In order to illustrate technical solutions described in the present application, specific examples are provided below.

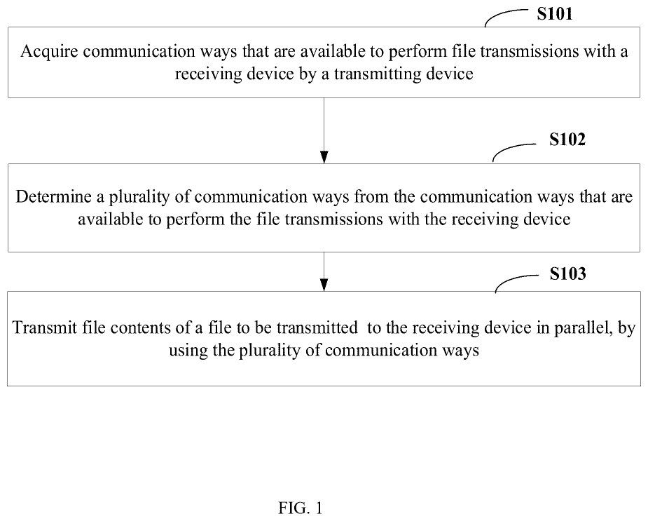

FIG. 1 shows an implementation flowchart of the method for transmitting file provided in one embodiment of the present application. The details are described as follows:

S101, the transmitting device acquires communication ways that are available to perform file transmissions with the receiving device.

In actual applications, the communication ways supported by each terminal device may be same or different. For example, among common terminal devices, smartphones generally support communication ways such as Wi-Fi, BLUETOOTH, cellular networks, NFC, and data lines, and tablets generally support communication ways such as Wi-Fi, BLUETOOTH, NFC, and data lines. Desktop computers or laptops support communication ways such as Wi-Fi, BLUETOOTH, and wired broadband.

In order to implement file transmissions, it is necessary to confirm that the transmitting device and the receiving device support a communication way of transmitting files to each other. In the embodiments of the present application, file transmissions between terminal devices can be divided into two situations:

Situation one: a direct transmission between terminal devices.

Situation two: terminal devices access a local area network or a wide area network, and files are transmitted based on an accessed network.

Regarding situation one, communication ways such as Wi-Fi, BLUETOOTH, NFC and wired connections can be implemented. At this time, both of the transmitting device and the receiving device need to support a same communication way. For example, when the transmitting device and the receiving device have Wi-Fi capabilities at the same time, Wi-Fi can be used for direct transmission. For another example, BLUETOOTH can be used for direct transmission when the transmitting device and the receiving device have BLUETOOTH capabilities at the same time.

Regarding situation two, communication ways such as Wi-Fi and cellular network with a capability of accessing the local area network or wide area network are required to achieve this. At this time, the transmitting device and the receiving device do not need to use a same communication way for transmitting file. For example, the transmitting device accesses the Internet through Wi-Fi, and the receiving device accesses the Internet through the cellular network. At this time, the transmitting device and the receiving device can still transmit files to each other.

Based on the above two situations, before transmitting files in the embodiments of the present application, the transmitting device firstly needs to determine communication ways that can transmit files with the receiving device. It facilitates subsequent determination of a specific communication way to be used. Among them, the embodiments of the present application do not make too many restrictions on the implementation method of determining communication ways supported by the transmitting device and the receiving device, and the communication ways can be selected or set by technicians according to actual needs.

As an optional implementation method for determining the communication ways supported by the transmitting device and the receiving device. In some embodiments of the present application, the transmitting device can inquire the receiving device whether the receiving device supports a corresponding communication way, according to the communication way that the transmitting device supports. At this time, S101 can be replaced by: S1011 and S1012.

S1011, the transmitting device sends communication way information that the transmitting device supported to the receiving device.

S1012, the transmitting device receives the communication way information that are available to perform file transmissions returned by the receiving device in response to the communication way information of the transmitting device, and determines the communication way that are available to perform the file transmissions with the receiving device based on received communication way information.

In the embodiments of the present application, since the transmitting device is not sure which communication ways the receiving device supports, the transmitting device can firstly inform the receiving device of the communication ways that the transmitting device supports. Correspondingly, the communication ways supported by the transmitting device are recorded in the communication way information supported by the transmitting device.

After receiving the communication way information, the receiving device can acquire the communication ways supported by the transmitting device. At this time, the receiving device refers to the communication ways supported by itself for performing a match, to determine which communication ways can be used for transmitting file with the transmitting device. Then the receiving device notifies the transmitting device of these determined communication ways. That is, information about the communication ways that are available to perform file transmissions is returned to the transmitting device.

For example, it is assumed that the transmitting device supports Wi-Fi, BLUETOOTH and NFC, while the receiving device only supports Wi-Fi and BLUETOOTH. At this time, Wi-Fi and BLUETOOTH are the communication ways that the transmitting device and the receiving device can be utilized for transmitting file. Correspondingly, at this time, the receiving device returns information of recorded communication ways of Wi-Fi and BLUETOOTH to the transmitting device. After the transmitting device receives returned information of recorded communication ways, the transmitting device can acquire the communication ways supported by the transmitting device and the receiving device, such as Wi-Fi and BLUETOOTH.

Another optional implementation method for determining the communication ways supported by the transmitting device and the receiving device is provided. In the embodiments of the present application, the receiving device can determine the transmitting device whether it supports corresponding communication ways according to the communication ways that the receiving device supported. At this time, S101 can be replaced by: S1013 and S1014.

S1013, the receiving device sends communication way information that supported by the receiving device to the transmitting device.

S1014, the transmitting device receives the communication way information supported by the receiving device from the receiving device, and determines the communication ways that are available to perform the file transmissions with the receiving device.

The difference between this embodiment of the present application and the prior embodiment is that in this embodiment of the present application, the receiving device firstly notifies the transmitting device of the communication ways that the receiving device supported. The transmitting device determines the communication ways that are available to perform the file transmissions with the receiving device, based on the communication ways supported by the receiving device. Among them, the receiving device can actively execute S1013 and inform the transmitting device of the communication ways that the receiving device supported. It is also possible that, before S1013, the transmitting device firstly sends an inquiry request. After receiving the inquiry request, the receiving device performs an operation as described in S1013. No restrictions is limited here and can be determined according to actual requirements.

In the above two embodiments of the present application, through active or passive communication between the transmitting device and the receiving device, the other device can be informed of the communication ways supported by itself, thereby accurately determining all of the communication ways supported by both of the devices that can carry out the file transmissions. Both embodiments can be applied to various actual application scenarios, and can accurately determine all communication ways supported by the transmitting device and the receiving device for performing the file transmissions, and have extremely strong compatibility of the application scenarios. At the same time, an actual communication way can be selected accurately throughout subsequent stages.

In another optional implementation method for determining the communication ways supported by the transmitting device and the receiving device of the present application, several default communication ways can be preset by technical personnel as communication ways through which the transmitting device and the receiving device can transmit files. At this time, S101 can be replaced by: the transmitting device reads a plurality of preset communication ways and uses them as the communication ways for transmitting file with the receiving device.

The embodiments of this application can be applied to a variety of practical scenarios. The practical scenarios include, but are not limited to some scenarios, in which the transmitting device and the receiving device are fixed, and the communication ways supported by the two devices are also relatively fixed. For another example, smart devices often support a variety of communication ways, and supported communication ways are often similar in type and quantity. In these scenarios, based on some default preset communication ways, the time for the transmitting device to execute S101 for determining the communication ways with the receiving device can be shortened, thereby reducing entire file transmissions time.

S102, the plurality of communication ways are determined from the communication ways that are available to perform the file transmissions with the receiving device.

Considering that there may be many communication ways for transmitting file between the transmitting device and the receiving device, all of them can theoretically be used for transmitting file. However, in actual applications, if all of the communication ways are turned on, it leads to performance degradation and excessive power consumption of terminal device, thus the user experience is affected. Therefore, after determining the communication ways that are available to perform the file transmissions with the receiving device in S101, some or all of the communication ways can be selected in the embodiments of the present application. Among them, the embodiments of the present application do not make too many restrictions on a specific selection way, thus it can be selected or set by technicians according to actual needs. For example, the transmitting device can select only top “m” communication ways with faster transmission speeds, “m” can be any natural number greater than one.

As an optional implementation method for selecting communication ways, in some embodiments of the present application, a number of communication ways to be selected can be set by technical personnel according to actual needs. On this basis, S102 may be replaced by: a preset number of communication ways are determined for transmitting files from the communication ways, which are available to perform the file transmissions with the receiving device.

As another optional implementation method for selecting communication ways, in some embodiments of the present application, technicians can set the number of communication ways to be selected according to actual needs, and set a rule or a method for sorting the communication ways. On this basis, S102 can be replaced with: S1021.

S1021, the communication ways that are available to perform the file transmissions with the receiving device are sorted, and a preset number of top sorted communication ways are determined as communication ways for the file transmissions.

Among them, a specific sorting method is not limited here and can be set by technical personnel. For example, in some embodiments, the communication ways may be sorted according to a transmission speed from fast to slow, the communication ways may be sorted according to an order of a transmission stability of the communication ways from best to worst. In the same way, the preset number is not limited here and can be any natural number greater than one.

As another optional implementation method for selecting communication ways, on the basis of the previous embodiment, in the embodiments of the present application, comprehensive sorting can be performed based on the transmission speed and the transmission stability of the communication ways at the same time. At this time, S102 can be replaced by: S10211 and S10212.

S10211, based on the transmission speed and the transmission stability of the communication ways, a transmission quality of the communication ways that are available to perform the file transmissions with the receiving device is evaluated, and the communication ways are sorted from high to low according to the transmission quality.

S10212, the preset number of top sorted communication ways are determined as communication ways for the file transmissions.

In this embodiment of the present application, the transmitting device evaluates a transmission quality of the communication ways based on the transmission speed and the transmission stability, and the transmitting device selects the top several communication ways with the best transmission quality as the communication ways for the file transmissions. Among them, a specific method for evaluating the transmission quality is not limited here and can be set by technical personnel. For example, in some optional embodiments, a weighted summation of the transmission speed and the transmission stability may be performed, and a sum value may be used as a score of the transmission quality. A higher score indicates a higher transmission quality.

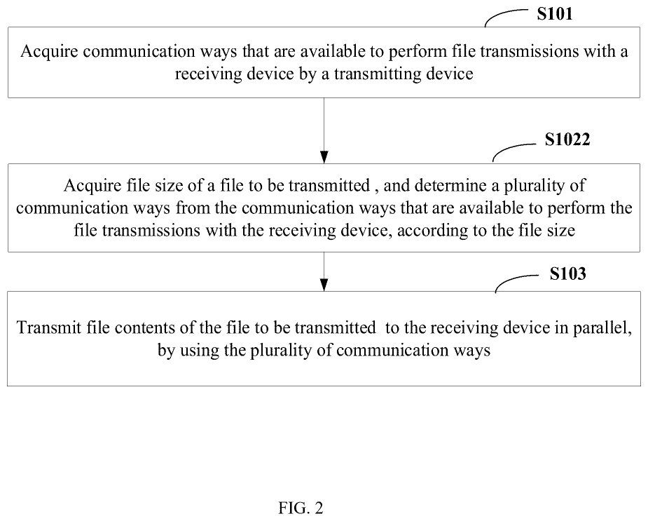

As another optional implementation method for selecting communication methods, in some embodiments of the present application, a type and a number of required communication ways can be selected according to an actual required size of transmission file (e.g., the file to be transmitted). On this basis, referring to FIG. 2, S102 can be replaced with: S1022.

S1022, file size of the file to be transmitted is acquired, and the plurality of communication ways are determined from the communication ways that are available to perform the file transmissions with the receiving device, according to the file size.

In some embodiments, if the communication ways are used more, file transmissions efficiency is higher. However, considering that in actual applications, when the file size is small, a smaller number of communication ways can also achieve rapid file transmissions. At this time, if more communication ways are used for the file transmission, on the one hand, it will increase power consumption of the transmitting device, and on the other hand, it may also affect the user experience. Therefore, in this embodiment of the present application, the type and the number of required communication ways are determined based on the file size of the file to be transmitted. A specific determination method is not limited here and can be selected or set by technicians according to actual needs. As an optional embodiment of the present application, a relation between the file size and the type and the number of communication ways can be set, and a final communication way can be determined based on the actual file size and the relation.

As an optional embodiment of the present application, one or more size thresholds can be set, and when the file size has a different size relationship from a size threshold, a corresponding type and number of communication ways can be set. On this basis, the transmitting device determines the type and the number of communication ways based on the relationship between the actual file size of the file to be transmitted and the size threshold, and determines the final communication way. For example, it is assumed that a size threshold is set to 50M, and the transmitting device selects as many as possible from Wi-Fi, cellular network, BLUETOOTH and wired transmission when the file to be transmitted is larger than 50M. When the file to be transmitted is less than 50M, the transmitting device selects any two communication ways from Wi-Fi, cellular network, BLUETOOTH and wired transmission.

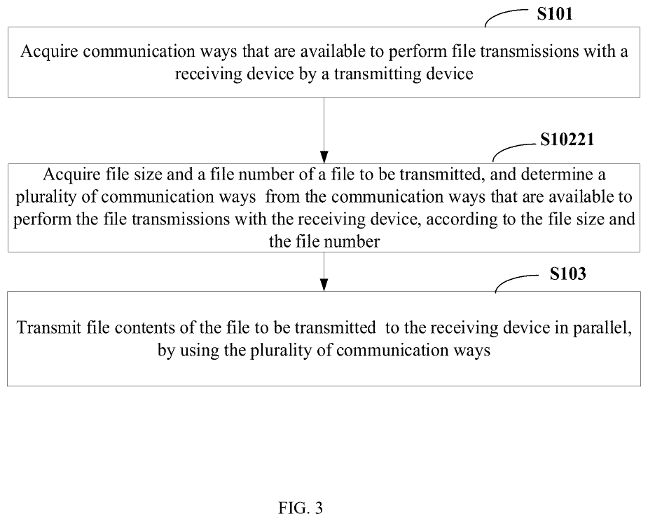

Based on the previous embodiment, this is another optional implementation method for selecting communication ways. In the embodiments of the present application, the number of files to be transmitted may be more than one. In this situation, the type and the number of required communication ways may be selected according to the file size and the number of files to be transmitted. On this basis, referring to FIG. 3, S102 can be replaced with: S10221.

S10221, the file size and a file number of the file to be transmitted are acquired, and the plurality of communication ways are determined from the communication ways that are available to perform the file transmissions with the receiving device, according to the file size and the file number.

It has been found in practical applications that when there are a large number of files to be transmitted, even if a total file size is not large, a transmission speed of a single communication way still be relatively slow. The file size in the embodiments of the present application refers to the total file size of files to be transmitted. Thus, the transmitting device selects a communication way based on both of the file size and the file number, and a balance between transmission speed and power consumption of the transmitting device, and user experience can be achieve. Among them, the embodiments of the present application do not make any limitations on the method for determining the communication ways based on the file size and the number of files, and specific methods can be selected or set by technicians according to actual needs. As an optional embodiment of the present application, a correspondence relationship between the file size, the file number, a type and a number of the communication ways can be set, and a final communication way can be determined based on an actual file size, an actual file number, and the correspondence relationship.

As an optional embodiment of the present application, the file size and the file number can be divided into a plurality of situations, and the type and the number of the communication ways corresponding to each situation can be set. On this basis, the transmitting device determines the type and the number of the communication ways based on the actual file size and the file number of files to be transmitted, and determines the final communication way. For example, assumed that the file size and the file number are divided into three situations. The type and size and the file number of communication ways corresponding to each situation are described as follows:

In situation a, the file size is greater than 50M, and the file number can be any value. In this embodiment, the transmitting device chooses as much as possible from Wi-Fi, cellular network, BLUETOOTH, and wired transmission.

In situation b, the file size is less than or equal to 50M, and the file number is greater than two. In this embodiment, the transmitting device chooses as much as possible from Wi-Fi, cellular network, BLUETOOTH, and wired transmission.

In situation c, the file size is less than or equal to 50M, and the file number is less than or equal to two. The transmitting device chooses any two communication ways from Wi-Fi, cellular network, BLUETOOTH and wired transmission.

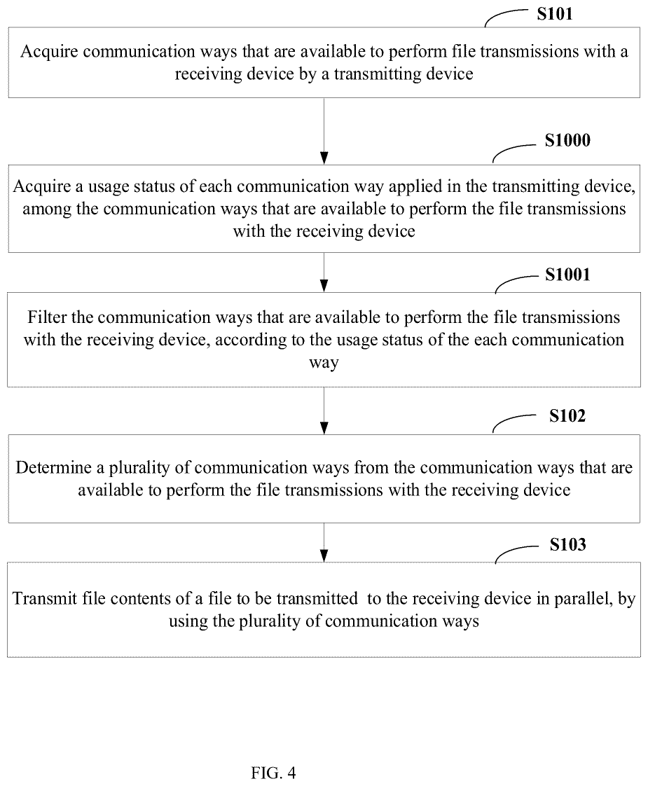

As another optional implementation method for selecting communication ways, considering that in actual situations, when users need to transmit files, they may also use other functions that occupy communication ways. For example, the users may utilize Wi-Fi to play videos online, make video calls through the cellular networks, or play music through BLUETOOTH headsets. In these scenarios, the users have real-time needs for occupying communication ways. Therefore, if the transmitting device utilizes these occupied communication ways to transmit files, it may have a certain impact on user's normal use of the transmitting device. For example, the online videos lag, the video calls freezes, or the BLUETOOTH headset plays music intermittently can be caused. Based on these situations, the transmitting device can first filter the communication ways according to a usage status of each communication way, and then perform a determination operation of the communication ways in S102. Based on these situations, referring to FIG. 4, in the embodiments of the present application, after S101 and before S102, S1000 and S1001 are also included.

S1000, a usage status of each communication way applied in the transmitting device is acquired among the communication ways, which are available to perform the file transmissions with the receiving device.

S1001, the communication ways that are available to perform the file transmissions with the receiving device are filtered, according to the usage status of each communication way, and an operation as described in S102 is performed, based on remaining communication ways after filtering.

In one embodiment, S102 can be adaptively adjusted to determine a plurality of communication ways for the file transmissions from the remaining communication ways after filtering.

In the embodiments of the present application, the usage status of each communication way is classified to an idle status and an in-use status. The idle status represents that the communication way currently has no data or file transmissions tasks, and the in-use status represents that the communication ways currently have data or file transmissions tasks. All communication ways in the idle status can be retained during a filtering procedure for selection in S102. For communication ways that are in the in-use status, considering that the user is currently using them, in order to reduce the impact on the user experience, the transmitting device can choose to exclude some or all of them when filtering. The embodiments of the present application do not make limitations on the processing methods of specific communication way in the in-use status, and can be set by technicians themselves.

As an optional embodiment of the present application, there are two optional processing methods of communication ways in the in-use status in the present application:

Processing method one: when filtering, all communication ways that are in the in-use status are removed.

Processing method two: when filtering, a number of all communication ways that are in idle status is counted. In response that the number of all communication ways that are in idle status is greater than or equal to two, the transmitting device eliminates all communication ways in the in-use status. In response that the number of all communication ways that are in idle status is less than two, the transmitting device selects some or all communication ways from the communication ways in the in-use status and retains the selected communication ways, and eliminates rest communication ways that have not been selected. In some embodiments, a sum of the number of retained communication ways in the in-use status and the number of communication ways in idle status can be greater than or equal to two.

In actual applications, technicians can choose the processing method to be used according to actual needs. Other processing methods can also be set by technicians themselves.

As an optional embodiment of the present application, the S101 and the S102 are essentially to determine the communication ways used for file transmissions. Therefore, in this embodiment of the present application, S101 and S102 can be replaced together by: acquiring a plurality of communication ways.

On the basis of replacing S101 and S102 together by “acquiring a plurality of communication ways” as another optional embodiment of the present application. In the embodiments of the present application, a certain number and type of communication ways can be preset by technical personnel. At this time, there is no need to select the communication way in S101 and S102 to increase overall file transmissions speed. The number and types of specific communication ways are not limited here and can be set by technicians according to actual needs.

S103, file contents of a file to be transmitted are transmitted to the receiving device in parallel, by using the plurality of communication ways.

After determining communication ways to be used, the transmitting device starts transmitting files. In order to improve transmission efficiency and increase transmission speed, the transmitting device transmit the file contents of the file to be transmitted in parallel by using the plurality of communication ways, that is, the plurality of communication ways can transmit different file contents at the same time. Among them, the embodiments of the present application do not make any restriction on specific parallel transmission method, which can be set by technical personnel according to actual needs. For example, in some optional embodiments, various communication ways can be used to start parallel transmission of file contents starting from different locations in the files to be transmitted until all file contents of all files to be transmitted have been transmitted to the receiving device.

In this embodiment of the present application, the file contents of the file to be transmitted are transmitted in parallel by determining the communication ways that are available to the transmitting device and the receiving device through a filtering procedure, and the transmitting device selects a plurality of communication ways from the communication ways that are available to the transmitting device and the receiving device. Therefore, by comparing with a traditional single communication method for transmitting files, the embodiments of the present application can improve the file transmissions efficiency and improve the file transmissions speed. The user experience of transmitting files can be improved.

As an example of the present application, theoretically, all the file contents of the file to be transmitted can be sent to the receiving device, and the file to be transmitted can be transmitted completely. In an actual process of file transmissions, the transmitting device or the receiving device can determine a completion of transmission. For example, for the transmitting device, the transmitting device determines whether all the file contents of the file to be transmitted have been sent through the communication ways. For the receiving device, the receiving device determines whether all the file contents of the file to be transmitted have been received. The embodiments of this application do not limit a device that specifically determines whether the transmission is completed. It can be done either by the transmitting device or the receiving device, and details can be determined according to actual application conditions. When the device of judgment is the receiving device, the receiving device can inform the transmitting device of the completion of the transmission after judging that the transmission is completed. At the same time, the embodiments of this application do not make any restrictions on the method for determining whether the transmission is completed, and it can also be set by technicians themselves.

In addition, after completing the transmission, the receiving device can also perform an integrity verification on the received files to be transmitted to avoid transmission problems or transmission identification. The method of integrity verification is not too limited here and can be set by technicians themselves. For example, hash verification can be used for integrity verification.

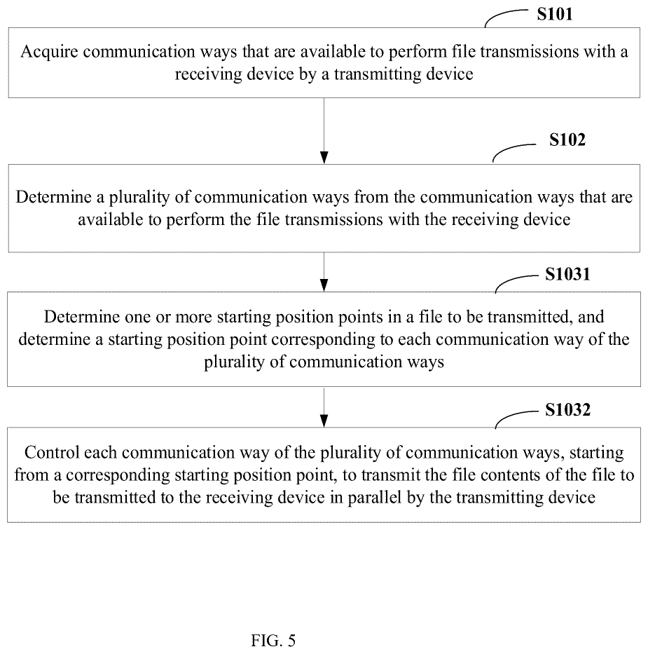

As an optional implementation method for implementing parallel transmission of files to be transmitted in the present application, referring to FIG. 5, in this embodiment of the present application, S103 can be replaced by S1031 and S1032:

S1031, one or more starting position points are determined in the file to be transmitted, and a starting position point corresponding to each communication way of the plurality of communication ways is determined.

In this embodiment of the present application, in order to realize parallel transmission of file contents, one or more starting position points are firstly determined in the file to be transmitted. And the transmitting device determines the corresponding starting position point for each communication way. Among them, it is considered that, except a file header and an end of the file, file contents at both sides of any position point can be read and transmitted based on the any position point. During a file transmissions process, a same file content does not need to be transmitted repeatedly through the communication ways. Therefore, when the file header and the end of the file are used as the starting position points, the transmitting device may use one corresponding communication way. Except the file header and the end of the file, a single starting position point can correspond to one or two communication ways, but each communication way corresponds to a starting position point. On the basis of this situation, the embodiments of this application do not make any restrictions on the method for determining the starting position points in the file to be transmitted, a number of starting position points, and a corresponding relationship between each starting position point and the communication way. Technical personnel can set according to actual needs.

In an optional embodiment of the present application, the file header and the end of the file can be used as two fixed starting position points. At this time, in response that only two communication ways are used for file transmissions, in S1031, the two communication ways can correspond to the two starting position points, and an operation of S1032 can be performed.

In an optional implementation method for determining the starting position points and the specific number of the starting position points in this application, it is assumed that the number of communication ways that are finally determined for file transmissions is “m”, and a total number of starting position points is “h”. “m” is a natural number that is greater than one, and “h” is a natural number that is greater than or equal to one. In order to make each communication way have a starting point for file content transmission, in the embodiments of the present application, a value range of “h” is determined as follows:

When “m” is an odd number, the value range of “h” can be represented as (m+1)/2≤h≤m. When h=(m+1)/2, among a number “h” of starting position points, at most one starting position point can be the file header or the end of the file. That is, in this embodiment, the starting position points do not include the file header and do not include the end of the file, or only one of the file header and the end of the file is determined to be the starting position point.

When m is an even number, the value range of “h” can be represented as m/2≤h≤m. When h=m/2, the number “h” of starting position points do not include the file header and do not include the end of the file.

Within the above value range, technicians can select a specified number of starting position points according to actual needs, and there is no more limitation here.

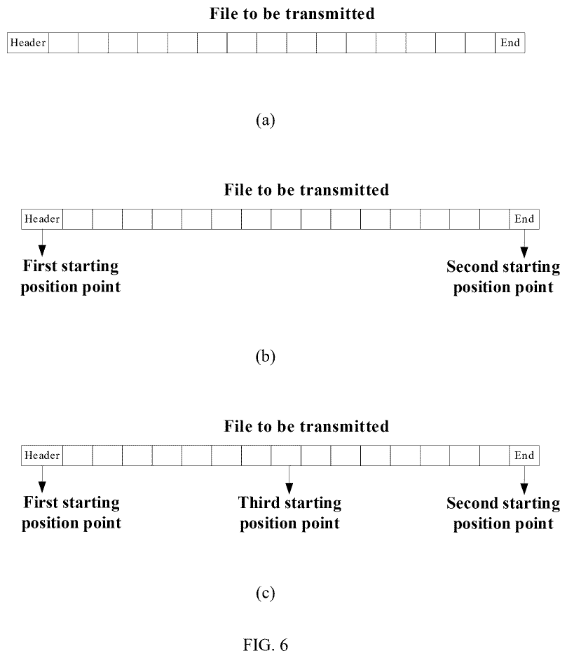

For example, assuming that m=2, thus 1≤h≤2. When h=1, the only one of the starting position point can be a position point in the file to be transmitted excluding the file header or the end of the file. Referring to part (a) of FIG. 6, the starting position point can be selected between the file header and the end of the file. When h=2, theoretically, any two position points in the file to be transmitted can be selected as the starting position points. For example, the transmitting device uses both of the file header and the end of the file as the starting position points.

It should be noted that in all embodiments of the present application, a determination of the starting position point can be determined by the transmitting device, or can be determined by the receiving device and notified to the transmitting device. When the receiving device determines the starting position points, any processing or determination logic involved in the starting position points is implemented by the receiving device. Correspondingly, S1031 can be: the transmitting device receives one or more starting position points sent by the receiving device, and a starting position point corresponding to each of the communication ways. The embodiments of the present application do not limit a device that determines the starting position points, and the device can be set by technicians themselves.

S1032, the transmitting device controls each communication way of the plurality of communication ways, starting from a corresponding starting position point, to transmit the file contents of the file to be transmitted to the receiving device in parallel.

After determining the starting position point corresponding to each communication way, the transmitting device reads the file contents of the file to be transmitted from the starting position point, and controls each communication way to transmit the file contents read from the corresponding starting position point in parallel.

In an example for illustration, with reference to part (b) of FIG. 6, assumed that there are two communication ways used, namely a first communication way and a second communication way, and there are two starting position points, such as the file header (a first starting position point) and the end of the file (a second starting position point). And the first communication way corresponds to the file header, and the second communication way corresponds to the end of the file. On this basis, the transmitting device reads the file contents of the file to be transmitted starting from the file header and the end of file respectively. At the same time, the transmitting device transmits file contents read from the file header to the receiving device through the first communication way. File contents read from the end of the file are transmitted to the receiving device using the second communication way.

To illustrate with another example, referring to part (c) of FIG. 6, the embodiment of the present application is based on the embodiment of part (b) of FIG. 6, and a third communication way and a third corresponding starting position point are added. The third starting position point can be anywhere between the file header and the end of the file. Based on the embodiment in part (b) of FIG. 6, the transmitting device also reads the file contents of the file to be transmitted starting from the third starting position point. By using the third communication way, the file contents read from the third starting position point are sent to the receiving device in parallel with the first communication way and the second communication way.

In the embodiments of the present application, a corresponding starting position point is set for each communication way, and the file contents are transmitted starting from the respective starting position point. A variety of communication ways can be used to achieve synchronous transmission of files to be transmitted. This improves a transmission efficiency and speed of files to be transmitted.

As an optional implementation method for determining the starting position point in this application. In this embodiment of the present application, S1031 can be replaced by: S10311 and S10312.

S10311, transmission workload of each communication way of the plurality of communication ways is acquired.

In some embodiments, the transmission workload of each communication way refers to an amount of file contents required to be transmitted by each communication way during the file transmissions process. The embodiments of this application do not make any restrictions on the setting method of the transmission workload, which can be determined according to actual needs. For example, in some optional embodiments, the transmission workload may be preset by technicians. For example, technicians can set proportion of transmission workload between various communication ways. In S10311, the transmitting device confirms a final actual transmission workload of each communication way based on the proportion of transmission workload and the actual situation of the files to be transmitted. In other optional embodiments, considering that the actual transmission capabilities of different communication ways are different, there will be a certain difference in the transmission speed of the file contents. In order to make full use of the transmission capabilities of each communication way to improve the overall transmission speed of the files to be transmitted, the corresponding transmission workload can be determined according to the transmission speed of the communication way. The transmission workload of a single communication way is positively related to its transmission speed, for example, the transmission workload of a single communication way is proportional to its transmission speed.

S10312, according to the proportion of transmission workload of each communication way of the plurality of communication ways, one or more starting position points in the file to be transmitted are determined, and a corresponding starting position point to each communication way of the plurality of communication ways is determined.

Since the starting position point is a position where each communication way starts transmitting file contents, in order to match the transmission workload of the communication way with the starting position point as much as possible to increase the transmission speed, in this embodiment of the present application, a position of a transmission file is determined based on the proportion of transmission workload between the communication ways, thereby determining the position point that can be used as the starting position point. The transmitting device selects a required starting position point from the determined position points. For relevant descriptions of the starting position point, please refer to the descriptions of S1031, which is not be described again here.

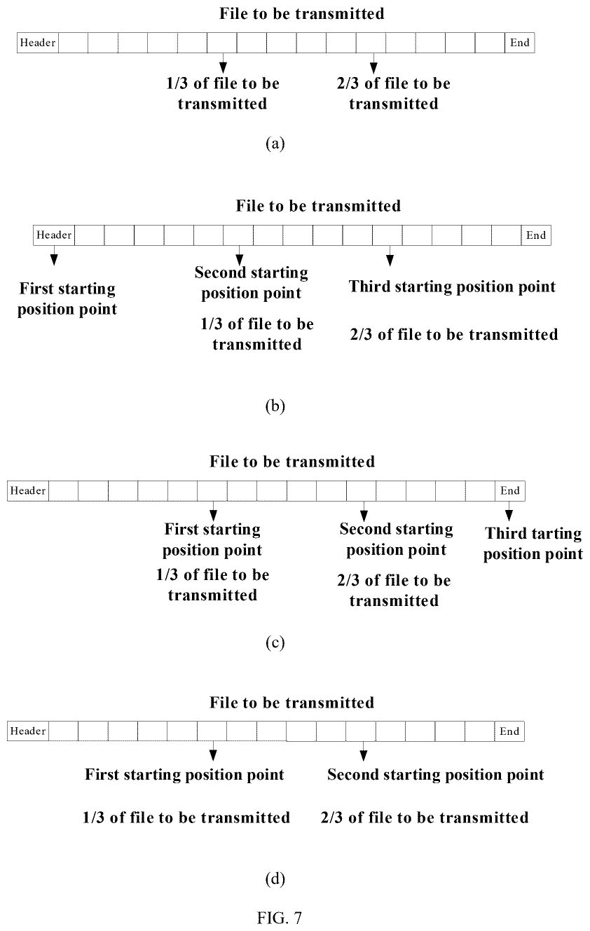

For example, assumed that three communication ways, such as the first communication way, the second communication way and the third communication way, are used to transmit file contents, and the proportion of transmission workload of the three communication ways is 1:1:1. At this time, referring to part (a) of FIG. 7, the transmitting device can position the file contents of the file to be transmitted according to 1:1:1. The transmitting device gets four available position points, for example the file header, ⅓ of the file to be transmitted, ⅔ of the file to be transmitted, and the end of file. On this basis, there are three solutions for selecting the starting position points, as follows:

In a first solution: the file header, ⅓ of the file to be transmitted, and ⅔ of the file to be transmitted are used as the starting position points. At this time, reference can be referred to part (b) of FIG. 7.

In a second solution: ⅓ of the file to be transmitted, ⅔ of the file to be transmitted and the end of the file are used as the starting position points. At this time, reference can be referred to part (c) of FIG. 7.

In a third solution: ⅓ of the file to be transmitted and ⅔ of the file to be transmitted are used as the starting position points. At this time, reference can be referred to part (d) of FIG. 7.

In the embodiment of the present application, by locating the starting position point according to the proportion of the communication workload of each communication way, the transmission workload of each communication way can be synchronously associated with the file content amount between the actual starting position points. Thus, during a subsequent transmission, each communication way can reduce a possibility of transmission through the starting position points. This improves the overall transmission speed of files to be transmitted.

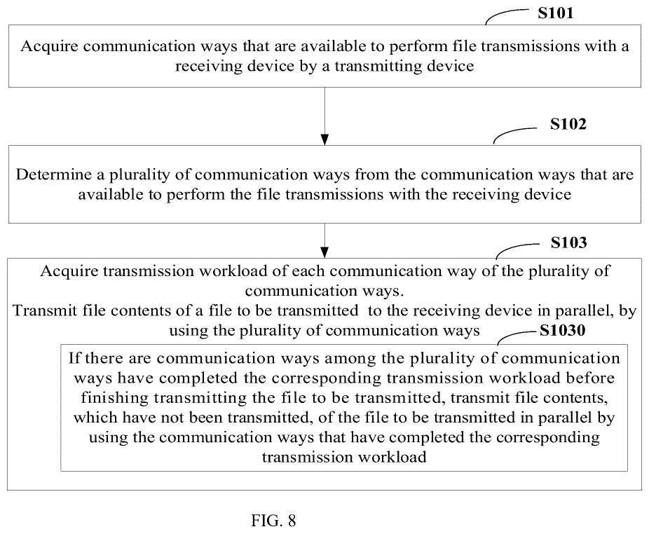

As an optional embodiment of the present application, in order to improve the transmission efficiency of the files to be transmitted, the transmission speed is increased. In this embodiment of the present application, corresponding transmission workload can be set for each communication way. The transmitting device adjusts a transmission method of the files to be transmitted based on the transmission workload completed by each communication way. Referring to FIG. 8, details are provided as follows:

In S103, transmission workload of each communication way of the plurality of communication ways is acquired.

Regarding a setting method of the transmission workload, please refer to the above-mentioned S10311, which is not described repeatedly here.

At the same time, when executing S103, the transmitting device transmit file contents of the file to be transmitted to the receiving device in parallel, by using the plurality of communication ways. The transmitting device monitors a completion of transmission workload of the each communication way.

Before completing the transmission of the file to be transmitted, in response that there are communication ways among the plurality of communication ways have completed the corresponding transmission workload before finishing transmitting the file to be transmitted, the embodiments of the present application provides at least two optional processing solutions:

In a first solution: each communication way can complete its own transmission workload. After completing its own transmission workload, the each communication way waits for transmissions of the file to be transmitted to be completed.

In a second solution: after the communication way completes its own transmission workload, completed communication way can assist other communication ways in transmitting the remaining untransmitted file contents. The transmission speed can be improved, and the transmission time can be retrieved. At this time, communication ways that have not completed transmission workload continue to transmit file contents.

For the first solution, the transmitting device does not need to perform any more operations at this time and can continue to transmit the file contents using the communication way being transmitted normally. For the second solution, a process for executing S103 also includes:

S1030, if there are communication ways among the plurality of communication ways have completed the corresponding transmission workload before finishing transmitting the file to be transmitted, file contents are transmitted, the file contents have not been transmitted, of the file to be transmitted in parallel by using the communication ways that have completed the corresponding transmission workload.

When a certain communication way completes its own transmission workload, it means that the communication workload is idle. At this time, the transmitting device uses idle communication ways to assist in transmitting remaining file contents, a utilization of the communication ways can be improved. Therefore, the transmission efficiency and the transmission speed can be improved, and the transmission time can be shortened. Among them, the embodiments of the present application do not make any restrictions on a method for assisting in transmitting the remaining file content. The method for assisting in transmitting the remaining file content can be selected or set by technicians according to actual needs. For example, in some optional embodiments, the communication way with the largest remaining transmission workload can be found and used as a target communication way. The transmitting device transmits the remaining transmission workload of the target communication way in parallel, by using the idle communication way and the target communication way. In other optional embodiments, the transmitting device determines a communication way with the lowest completion degree of transmission workload as the target communication way. The transmitting device transmits the remaining transmission workload of the target communication way in parallel, by using the idle communication way and the target communication way. Among them, remaining transmission workload of a single communication way divided by total transmission workload equals a completion degree of the transmission workload of the single communication way.

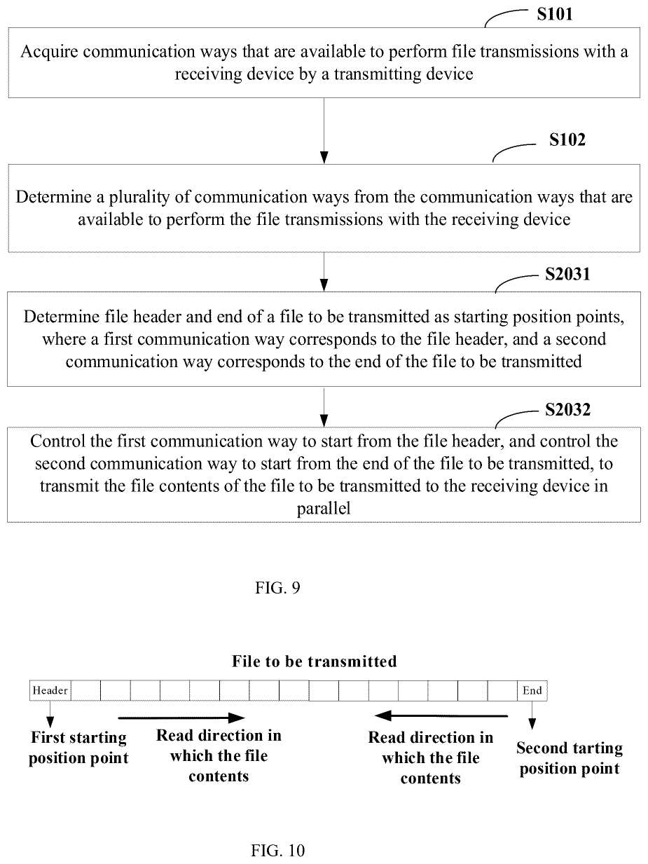

As an optional embodiment of this application. Based on the embodiment corresponding to FIG. 5, in the embodiments of the present application, there are two communication ways, such as a first communication way and a second communication way, are used for file transmissions. There are two starting position points, which are a file header and an end of the file to be transmitted. The first communication way corresponds to the file header, and the second communication way corresponds to the end of the file to be transmitted. In the embodiment of the present application, the first communication way and the second communication way may be selected through S101 and S102, or may be selected based on preset settings by technicians, which are not limited here. Correspondingly, referring to FIG. 9, in this embodiment of the present application, S1031 and S1032 can be replaced by: S2031 and S2032.

S2031, the file header and the end of the file to be transmitted are determined as the starting position points, where the first communication way corresponds to the file header, and the second communication way corresponds to the end of the file to be transmitted.

S2032, the first communication way is controlled to start from the file header, and the second communication way is controlled to start from the end of the file to be transmitted, to transmit the file contents of the file to be transmitted to the receiving device in parallel.

Referring to FIG. 10, which is a schematic diagram of a scene during file transmissions in the embodiments of the present application. In the embodiments of the present application, the transmitting device reads the file contents of the file to be transmitted starting from the file header and the end of the file to be transmitted synchronously. At the same time, the first communication way is used to transmit the file contents read from the file header, and the second communication way is used to transmit the file contents read from the end of the file to be transmitted in parallel, until all of the file contents of the file to be transmitted are sent to the receiving device.

In the embodiments of the present application, two communication ways are used to transmit files, and the file contents are read and sent from the file header and the end of the file to be transmitted respectively. Since the file contents are transmitted from both ends, and there is no other starting position point between the two ends of the file to be transmitted, transmission tasks in the communication ways do not need to be divided. During a process of file transmissions, the two communication ways have no corresponding transmission workload. The transmitting device only needs to continuously read the file contents from both ends to the middle, and transmits the file contents by the two communication ways. The last two communication ways can synchronously complete transmission of final file contents at a certain point in the file to be transmitted, and neither of the two communication ways need to wait for the other communication way during the process of file transmissions. Therefore, on one hand, there is no need to allocate transmission tasks. On the other hand, an occurrence of idle communication ways can be avoided due to unreasonable division of the transmission workload. Furthermore, the communication transmission capabilities of the two communication ways can be maximized, the transmission efficiency and the transmission speed can be improved, and the transmission time can be reduced.

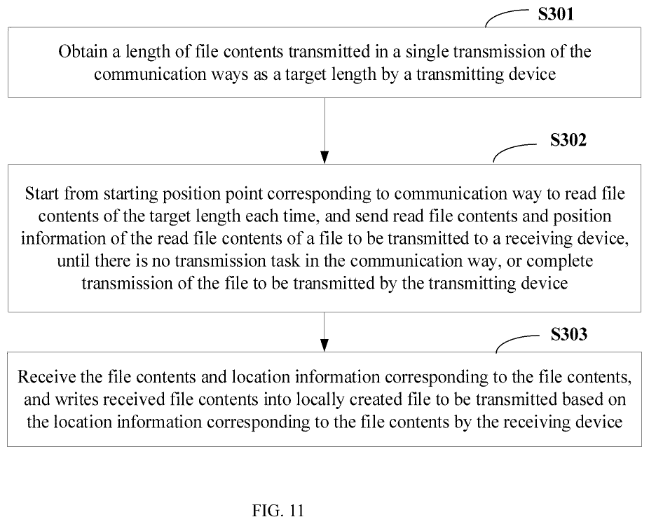

As a specific embodiment of transmitting the file contents by the communication way in this application, in order to realize transmission of the file contents of the file to be transmitted by the communication way, in the embodiments of the present application, the communication way only sends the file contents of a specified length to the transmitting device each time. At the same time, location information of the file contents of the file to be transmitted is also sent to the transmitting device so that the transmitting device can write the file contents. Referring to FIG. 11, details are provided as follows:

S301, the transmitting device obtains a length of the file contents transmitted in a single transmission of the communication ways as a target length.

Among them, the length of the file contents transmitted in the single transmission of the communication ways can be informed by the receiving device to the transmitting device by sending a request. The length of the file contents transmitted in the single transmission of the communication ways can also be set by technicians in advance based on an actual transmission principle and capabilities of the communication way.

Since the actual transmission principles and capabilities of each communication way are different, there may be certain differences in the target lengths corresponding to different communication ways. For example, in some optional embodiments, the target length of Wi-Fi can be set to 64K, and the target length of BLUETOOTH can be set to 4K.

S302, the transmitting device starts from the starting position point corresponding to the communication way to read the file contents of the target length each time, and the transmitting device sends read file contents and position information of the read file contents of the file to be transmitted to the transmitting device, until there is no transmission task in the communication way, or the transmitting device completes the transmission of the file to be transmitted.

The position information may be an offset position relative to file contents previously sent, or the offset position relative to the starting position point corresponding to the communication way, or the offset position may be a specific position point in the file to be transmitted.

In the embodiment of this application, the transmission of file contents through the communication way is a process of a plurality of transmissions. The transmitting device transmits the file contents to the receiving device in units of the target length, until there is no need to continue transmitting the file contents. It should be understood that the target length is theoretical length of the single transmission. In actual applications, there may be situations where a length of remaining untransmitted file contents of a certain communication way is less than the target length. At this time, the transmitting device transmits the file contents that is less than the target length, by using the communication way. For example, assumed that the target length of the first communication way is 128K, and the file contents to be transmitted needs to be transmitted using the first communication way, and only 64K of the file contents remains to be transmitted. At this time, the transmitting device can still use the first communication way to continue transmitting remaining 64K file contents.

S303, the receiving device receives the file contents and the location information corresponding to the file contents, and writes received file contents into locally created file to be transmitted based on the location information corresponding to the file contents.

Transmission methods in the embodiments of the present application is suitable for every communication way. In the embodiments of the present application, each communication way completes the transmission of file contents through a plurality of transmissions, so that the embodiment of the present application can better adapt to the actual characteristics of each communication way. The transmission efficiency and the transmission speed can be improved, the transmission time can be reduced.

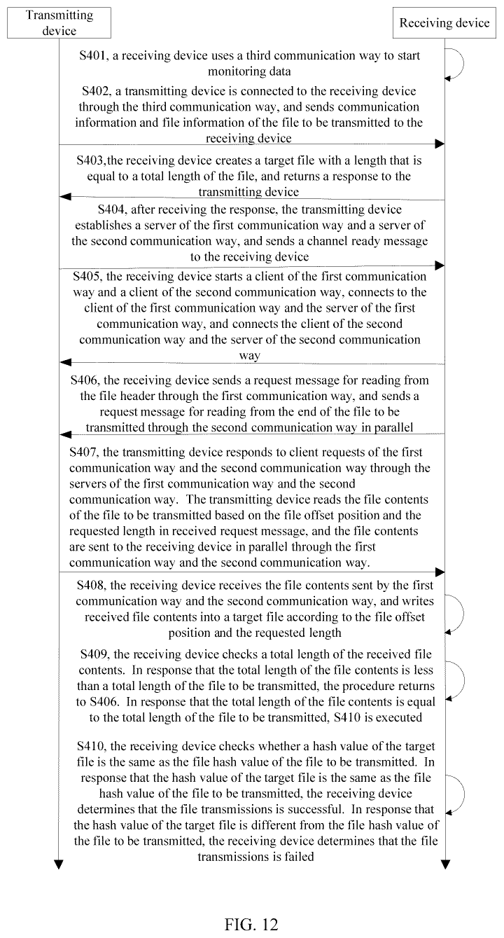

As a specific example of transferring files in this application, in the embodiments of the present application, the first communication way and the second communication way are used for file transmissions, and basic communication is performed based on the third communication way. There are two starting position points, which are the file header and the end of the file to be transmitted. The first communication way corresponds to the file header, and the second communication way corresponds to the end of the file to be transmitted. On this basis, referring to FIG. 12, which is a schematic diagram of system interaction according to the embodiments of the present application. Operations of file transmissions between the transmitting device and the receiving device are detailed as follows:

S401, the receiving device uses the third communication way to start monitoring data.

In the embodiments of the present application, the third communication way is a communication way for basic communication between the transmitting device and the receiving device. Specifically, the type of the third communication way can be determined according to the actual application scenario. It should be noted that the third communication way is only an example name. In actual application, the third communication way can also be the first communication way or the second communication way. In practical applications, the third communication way can be used as a basic communication way and also be one of the communication ways for transmitting files.

S402, the transmitting device is connected to the receiving device through the third communication way, and sends communication information and file information of the file to be transmitted to the receiving device. The file information includes a total file length of the file to be transmitted (that is, the file size) and a file hash value. The communication information includes information such as listening ports or channels of the first communication way and the second communication way.

S403, after receiving the communication information and the file information, the receiving device saves the communication information and the file information, creates a target file with a length that is equal to a total length of the file, and returns a response to the transmitting device.

S404, after receiving the response, the transmitting device establishes servers of the first communication way and communication way, and sends a channel ready message to the receiving device.

S405, after receiving the channel ready message, the receiving device starts clients of the first communication way and the second communication way, and connects to the servers of the first communication way and the second communication way respectively.

S406, the receiving device sends a request message for reading from the file header through the first communication way, and sends a request message for reading from the end of the file to be transmitted through the second communication way in parallel. The request message includes a file offset position where requested file contents begins and a requested length of the file contents.

S407, the transmitting device responds to client requests of the first communication way and the second communication way through the servers of the first communication way and the second communication way. The transmitting device reads the file contents of the file to be transmitted based on the file offset position and the requested length in received request message, and the file contents are sent to the receiving device in parallel through the first communication way and the second communication way.

In this embodiment of the present application, the receiving device selects the starting position point and informs the transmitting device. After receiving the corresponding request message, the transmitting device starts reading and sending the file contents according to the starting position points selected by the receiving device: the file header and the end of the file to be transmitted.

S408, the receiving device receives the file contents sent by the first communication way and the second communication way, and writes received file contents into a target file according to the file offset position and the requested length.

S409, the receiving device checks a total length of the received file contents. In response that the total length of the file contents is less than a total length of the file to be transmitted, the procedure returns to S406. In response that the total length of the file contents is equal to the total length of the file to be transmitted, S410 is executed.

In the embodiment of the present application, S406 to S409 is a loop procedure. The file contents are sent each time, the transmitting device reads the file contents with the requested length by the receiving device and sends the file contents out through corresponding communication ways. Regarding the file contents of the requested length, please refer to description of the target length in S301, which are not described repeatedly here.

In this embodiment of the present application, the receiving device checks whether the transmission of the file to be transmitted is completed based on the total length of the received file contents. In response that the transmission is not completed, operations from S406 to S409 are repeated. In response that the transmission is completed, the procedure continues to perform subsequent operation of S410.

S410, the receiving device checks whether a hash value of the target file is the same as the file hash value of the file to be transmitted. In response that the hash value of the target file is the same as the file hash value of the file to be transmitted, the receiving device determines that the file transmissions is successful. In response that the hash value of the target file is different from the file hash value of the file to be transmitted, the receiving device determines that the file transmissions is failed.

In the embodiments of the present application, by using two types of communications to transmit the file contents from the file header and the end of the file to be transmitted, the transmission capability of the communication way can be maximized. Compared with traditional file transmissions of single communication way, the transmission efficiency can be greatly improved, the transmission speed can be increased, and the transmission time can be shortened.

It should be understood that, assumed that there is no logical conflict, the above embodiments of the present application can be combined with each other to adapt to actual application requirements. The specific examples or implementations obtained after these combinations still fall within the protection scope of the present application.

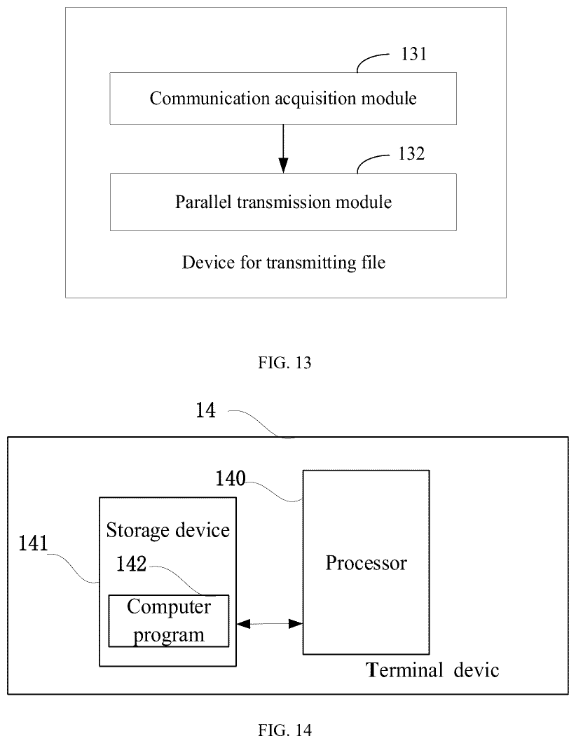

Corresponding to the method for transmitting file described in the above embodiment, FIG. 13 shows a schematic structural diagram of the device for transmitting file provided by the embodiments of the present application. For convenience of explanation, only the parts related to the embodiments of the present application are shown.

Referring to FIG. 13, the device for transmitting file includes:

A communication acquisition module 131 is configured to acquire a plurality of communication ways.

A parallel transmission module 132 is configured to transmit file contents of a file to be transmitted to a receiving device in parallel, by using the plurality of communication ways.

As an embodiment of the present application, the communication acquisition module 131 includes:

A communication acquisition submodule acquires communication ways that are available to perform file transmissions with the receiving device.

A communication filtering module is configured to determine the plurality of communication ways from the communication ways that are available to perform the file transmissions with the receiving device.

As an embodiment of the present application, the communication filtering module includes:

A first communication filtering module is configured to acquire file size of the file to be transmitted, and determine the plurality of communication ways from the communication ways that are available to perform the file transmissions with the receiving device, according to the file size. Or

A second communication filtering module is configured to acquire the file size and a file number of the file to be transmitted, and determine the plurality of communication ways from the communication ways that are available to perform the file transmissions with the receiving device, according to the file size and the file number. Or

The third communication filtering module is configured to acquire a transmission speed and a transmission stability of each of the communication ways that are available to perform the file transmissions with the receiving device, and determine the plurality of communication ways from the communication ways that are available to perform the file transmissions with the receiving device, according to the transmission speed and the transmission stability.

As an embodiment of the present application, the device for transmitting file also includes:

A status acquisition module is configured to acquire a usage status of each communication way applied in the transmitting device, among the communication ways that are available to perform the file transmissions with the receiving device.

A fourth communication filtering module is configured to filter the communication ways that are available to perform the file transmissions with the receiving device, according to the usage status of the each communication way, and perform an operation of determining the plurality of communication ways from the communication ways that are available to perform the file transmissions with the receiving device, based on remaining communication ways after filtering.

As an embodiment of the present application, the parallel transmission module 132 includes:

A position point determination module is configured to determine one or more starting position points in the file to be transmitted, and determine a starting position point corresponding to each communication way of the plurality of communication ways.

A parallel transmission submodule is configured to control each communication way of the plurality of communication ways, starting from a corresponding starting position point, to transmit the file contents of the file to be transmitted to the receiving device in parallel.

As an embodiment of the present application, the parallel transmission module 132 also includes:

A task size acquisition module is configured to acquire transmission workload of each communication way of the plurality of communication ways.

During a process of transmitting the file contents of the file to be transmitted to the receiving device in parallel, by using the plurality of communication ways, includes:

If there are communication ways among the plurality of communication ways have completed the corresponding transmission workload before finishing transmitting the file to be transmitted, transmit file contents, which have not been transmitted, of the file to be transmitted in parallel by using the communication ways that have completed the corresponding transmission workload.

As an embodiment of the present application, the plurality of communication ways include a first communication way and a second communication way. There are two starting position points, which include a file header and an end of the file to be transmitted. The first communication way corresponds to the file header, and the second communication way corresponds to the end of the file. In the embodiments of the present application, the parallel transmission submodule includes:

Controlling the first communication way to start from the file header, and controlling the second communication way to start from the end of the file to be transmitted, to transmit the file contents of the file to be transmitted to the receiving device in parallel.

For the process of each module in the device for transmitting file provided by the embodiments of the present application realizing their respective functions, reference may be made to the foregoing description of the embodiment shown in FIG. 1 and other related method embodiments, which not be described again here.

It should be noted that information interaction, execution process, etc. between the above-mentioned devices/units are based on the same concept as the method embodiments of the present application. For details of specific functions and technical effects, please refer to the method embodiments section.

It should be understood that a sequence number of each step in the above embodiment does not mean the order of execution. An execution order of each process should be determined by its function and internal logic, and should not constitute any limitation on the implementation process of the embodiments of the present application.

It should be understood that when used in this specification and appended claims, a term “including” indicates a presence of described features, integers, steps, operations, elements and/or components, but does not exclude the presence or addition of one or more other features, integers, steps, operations, elements, components and/or groups thereof.

It also should be understood that a term “and/or” as used in this specification and an appended claims refers to and includes any and all possible combinations of one or more of associated listed items.

As used in this specification and the appended claims, a term “if” may be construed depending on a context as “when” or “once” or “in response to determine” or “in response to detect”. Similarly, a phrase “if determined” or “if a described condition or an event is detected” may be construed, depending on the context, to mean “once determined” or “in response to determine” or “once detected the described condition or the event” or “in response to detection of the described condition or the event”.

In addition, in the description of the specification and the appended claims of the present application, terms “first”, “second”, “third” and so on are only used to distinguish descriptions, and should not be understood as indicating or implying relative importance. It should also be understood that, although the terms “first”, “second” etc. are used in the text to describe various elements in some embodiments of the present application, these elements should not be limited by these terms. These terms are only used to distinguish one element from another. For example, a first table could be named a second table, and similarly, a second table could be named a first table, without departing from the scope of the various described embodiments. The first table and the second table are both tables, but they are not the same table.

Reference to “one embodiment” or “some embodiments” or the like in the specification of the present application means that particular features, structures, or characteristics described in connection with the embodiment are included in one or more embodiments of the present application. Therefore, appearances of the phrases “in one embodiment”, “in some embodiments”, “in other embodiments”, “in other embodiments again” and the like in various places in this specification are not necessarily all referring to same embodiment, but mean “one or more but not all embodiments” unless expressly specified otherwise. Terms “including”, “comprising”, “having” and their variations mean “including but not limited to”, unless expressly specified otherwise.

The method for transmitting file provided by the embodiments of the present application can be applied to mobile phones, tablet computers, wearable devices, vehicle-mounted devices, augmented reality (AR)/virtual reality (VR) devices, notebook computers, super mobile personal computers, ultra-mobile personal computers (UMPCs), netbooks, and personal digital assistants (PDAs) and so on, the embodiments of the present application do not place any restrictions on specific types of terminal devices.

For example, the terminal device may be a station (ST) in a WLAN, a cellular phone, a cordless phone, a Session Initiation Protocol (SIP) phone, a Wireless Local Loop (WLL) station, Personal digital assistant (PDA) devices, handheld devices with wireless communication capabilities, computing devices or other processing devices connected to wireless modems, vehicle-mounted devices, Internet of Vehicles terminals, computers, laptops, handheld communication devices, handheld computing devices, satellite wireless devices, wireless modem cards, television set top boxes (STBs), customer premise equipment (CPE) and/or other equipment used to communicate over wireless systems and the next-generation communication systems, such as terminal device in 5G networks or terminal device in future evolved Public Land Mobile Network (PLMN) networks.

As an example and not a limitation, when the terminal device is a wearable device, the wearable device may also be a general term for devices that are wearable by applying wearable technology to intelligently design daily wear, such as glasses, gloves, Watches, clothing and shoes, etc. The wearable device is a portable device that is worn directly on the body or integrated into the user's clothing or accessories. Wearable devices are not just hardware devices, but also achieve powerful functions through software support, data interaction, and cloud interaction. Broadly defined wearable smart devices include full-featured, large-sized devices that can achieve complete or partial functions without relying on smartphones, such as smart watches or smart glasses, and those that only focus on a certain type of application function and need to be used in conjunction with other devices such as smartphones, various smart bracelets and smart jewelry for physical sign monitoring.

FIG. 14 is a schematic structural diagram of a terminal device (which can be the transmitting device or the receiving device) provided by an embodiment of the present application. As shown in FIG. 14, the terminal device 14 may including at least one processor 140( ), a storage device 141, and computer programs 142 stored in the storage device 141 and executable on the at least one processor 140, and when the at least one processor 140 executes the computer programs 142, it implements steps in any of the above-mentioned method embodiments, such as S101 to S103 in the embodiments shown in FIG. 1. Alternatively, when the at least one processor 140 executes the computer programs 142, it implements functions of each module/unit in each of the above device embodiments, such as functions of modules 131 to 133 shown in FIG. 13.

The terminal device 14 may be a computing device such as a desktop computer, a notebook, a PDA, a cloud server, etc. The terminal device may include but are not limited to the processor 140 and the storage device 141. Those skilled in the art can understand that FIG. 14 is only an example of the terminal device 14 and does not constitute a limitation on the terminal device 14. It may include more or less components than shown, or some components may be combined, or different components may be used. For example, the terminal device may also include an input sending device, a network access device, a bus, etc.

The processor 140 may be a Central Processing Unit (CPU), and may also be other general-purpose processors, Digital Signal Processor (DSP), Application Specific Integrated Circuit (ASIC), Field-Programmable Gate Array (FPGA) or other programmable logic devices, discrete gate or transistor logic devices, discrete hardware components, etc. A general-purpose processor may be a microprocessor, or the processor may be any conventional processor, or the like.

The storage device 141 may be an internal storage unit of the terminal device 14, such as a hard disk or memory of the terminal device 14. The storage device 141 may also be an external storage device of the terminal device 14, such as a plug-in hard disk equipped on the terminal device 14, a Smart Media Card (SMC), a Secure Digital (SD) card, Flash Card, etc. Further, the storage device 141 may also include both an internal storage unit of the terminal device 14 and an external storage device. The storage device 141 is used to store operating systems, application programs, boot loaders, data, and other programs, such as program codes of the computer programs. The storage device 141 can also be used to temporarily store data that has been output or will be output.

In addition, each functional unit in each embodiment of the present application can be integrated into one processing unit, each unit can exist physically alone, or two or more units can be integrated into one unit. The above integrated units can be implemented in the form of hardware or software functional units.

Embodiments of the present application also provides a terminal device, which includes a storage device, a processor, and computer programs stored in the storage device and operable on the processor, when the processor executes the computer programs, the steps in any of the above method embodiments can be implemented.

Embodiments of the present application also provide a computer-readable storage medium, the computer-readable storage medium storing computer programs, when the computer program is executed by a processor, the steps in any of the above method embodiments can be implemented.

Embodiments of the present application provide a computer program product. When the computer program product is run on a terminal device, the steps in the above method embodiments can be implemented when the terminal device executes it.

Embodiments of the present application also provide a chip system. The chip system includes a processor. The processor is coupled to a storage device, and when the processor executes computer programs stored in the storage device, the steps in the above method embodiments can be implemented when the terminal device executes it.

If the integrated module/unit is implemented in the form of a software functional unit and sold or used as an independent product, it can be stored in a computer-readable storage medium. Based on this understanding, the present application can implement all or part of the processes in the methods of the above embodiments, which can also be completed by instructing relevant hardware through a computer program. The computer programs can be stored in a computer-readable storage medium, and the computer programs are executed by the processor, the steps of each of the above method embodiments can be implemented. Wherein, the computer programs include computer program code, which may be in the form of source code, object code, executable file or some intermediate form. The computer-readable storage medium may include: any entity or device capable of carrying the computer program code, a recording medium, a USB flash drive, a mobile hard disk, a magnetic disk, an optical disk, a computer memory, and a read-only memory (ROM), random access memory (RAM), electrical carrier signals, telecommunications signals, and software distribution media, etc.

In the above embodiments, each embodiment is described with its own emphasis. For parts that are not detailed or documented in a certain embodiment, please refer to the relevant descriptions of other embodiments.

Those of ordinary skill in the art will appreciate that the units and algorithm steps of each example described in conjunction with the embodiments disclosed herein can be implemented with electronic hardware, or a combination of computer software and electronic hardware. Whether these functions are performed in hardware or software depends on the specific application and design constraints of the technical solution. Skilled artisans may implement the described functionality using different methods for each specific application, but such implementations should not be considered beyond the scope of this application.

The units described as separate components may or may not be physically separated. The components shown as units may or may not be physical units, that is, they may be located in one place, or they may be distributed to multiple network units. Some or all of the units can be selected according to actual needs to achieve the purpose of the solution of this embodiment.

Above-described embodiments are only used to illustrate the technical solutions of the present application, rather than to limit them. Although the present application has been described in detail with reference to the foregoing embodiments, those of ordinary skill in the art may modify the technical solutions described in the foregoing embodiments, or equivalent replacements for some of the technical features. However, these modifications or replacements do not deviate essence of corresponding technical solutions from spirit and scope of the technical solutions of the embodiments of the present application, and should be included in a protection scope of the present application.

1. A method for transmitting file, applied in a transmitting device, the method comprising:
acquiring a plurality of communication ways;
transmitting file contents of a file to be transmitted to a receiving device in parallel, by using the plurality of communication ways.

2. The method for transmitting file of claim 1, wherein acquiring the plurality of communication ways comprises:
acquiring communication ways that are available to perform file transmissions with the receiving device;
determining the plurality of communication ways from the communication ways that are available to perform the file transmissions with the receiving device.

3. The method for transmitting file of claim 2, wherein determining the plurality of communication ways from the communication ways that are available to perform the file transmissions with the receiving device comprises:
acquiring file size of the file to be transmitted, and determining the plurality of communication ways from the communication ways that are available to perform the file transmissions with the receiving device, according to the file size; or
acquiring the file size and a file number of the file to be transmitted, and determining the plurality of communication ways from the communication ways that are available to perform the file transmissions with the receiving device, according to the file size and the file number; or
acquiring a transmission speed and a transmission stability of each of the communication ways that are available to perform the file transmissions with the receiving device, and determining the plurality of communication ways from the communication ways that are available to perform the file transmissions with the receiving device, according to the transmission speed and the transmission stability.

4. The method for transmitting file of claim 2, before determining the plurality of communication ways from the communication ways that are available to perform the file transmissions with the receiving device, further comprising:
acquiring a usage status of each communication way applied in the transmitting device, among the communication ways that are available to perform the file transmissions with the receiving device;
filtering the communication ways that are available to perform the file transmissions with the receiving device, according to the usage status of the each communication way, and performing an operation of determining the plurality of communication ways from the communication ways that are available to perform the file transmissions with the receiving device, based on remaining communication ways after filtering.

5. The method for transmitting file of claim 1, wherein transmitting the file contents of the file to be transmitted to the receiving device in parallel, by using the plurality of communication ways comprises:
determining one or more starting position points in the file to be transmitted, and determining a starting position point corresponding to each communication way of the plurality of communication ways;
controlling each communication way of the plurality of communication ways, starting from a corresponding starting position point, to transmit the file contents of the file to be transmitted to the receiving device in parallel.

6. The method for transmitting file of claim 1, wherein transmitting the file contents of the file to be transmitted to the receiving device in parallel, by using the plurality of communication ways further comprises:
acquiring transmission workload of each communication way of the plurality of communication ways;
in response that there are communication ways among the plurality of communication ways have completed the corresponding transmission workload before finishing transmitting the file to be transmitted, transmitting file contents, which have not been transmitted, of the file to be transmitted in parallel by using the communication ways that have completed the corresponding transmission workload.

7. The method for transmitting file of claim 5, wherein the plurality of communication ways comprise a first communication way and a second communication way; there are two starting position points, which comprise a file header of the file to be transmitted and an end of the file to be transmitted; the first communication way corresponds to the file header, and the second communication way corresponds to the end of the file;
wherein controlling the each communication way of the plurality of communication ways, starting from the corresponding starting position point, to transmit the file contents of the file to be transmitted to the receiving device in parallel comprises:
performing a parallel transmission of transmitting the file contents of the file to be transmitted to the receiving device, by controlling the first communication way to start from the file header, and controlling the second communication way to start from the end of the file to be transmitted.

8-10. (canceled)

11. A terminal device comprising:
a processor; and
a storage device storing computer program, which when executed by the processor, cause the processor to:
acquire a plurality of communication ways;
transmit file contents of a file to be transmitted to a receiving device in parallel, by using the plurality of communication ways.

12. The terminal device of claim 11, wherein the processor is further caused to:
acquire communication ways that are available to perform file transmissions with the receiving device;
determine the plurality of communication ways from the communication ways that are available to perform the file transmissions with the receiving device.

13. The terminal device of claim 12, wherein the processor is further caused to:
acquire file size of the file to be transmitted, and determine the plurality of communication ways from the communication ways that are available to perform the file transmissions with the receiving device, according to the file size; or
acquire the file size and a file number of the file to be transmitted, and determine the plurality of communication ways from the communication ways that are available to perform the file transmissions with the receiving device, according to the file size and the file number; or
acquire a transmission speed and a transmission stability of each of the communication ways that are available to perform the file transmissions with the receiving device, and determine the plurality of communication ways from the communication ways that are available to perform the file transmissions with the receiving device, according to the transmission speed and the transmission stability.

14. The terminal device of claim 12, wherein the processor is further caused to:
acquire a usage status of each communication way applied in a transmitting device, among the communication ways that are available to perform the file transmissions with the receiving device;
filter the communication ways that are available to perform the file transmissions with the receiving device, according to the usage status of the each communication way, and perform an operation of determining the plurality of communication ways from the communication ways that are available to perform the file transmissions with the receiving device, based on remaining communication ways after filtering.

15. The terminal device of claim 11, wherein the processor is further caused to:
determine one or more starting position points in the file to be transmitted, and determine a starting position point corresponding to each communication way of the plurality of communication ways;
control each communication way of the plurality of communication ways, starting from a corresponding starting position point, to transmit the file contents of the file to be transmitted to the receiving device in parallel.

16. The terminal device of claim 11, wherein the processor is further caused to:
acquire transmission workload of each communication way of the plurality of communication ways;
in response that there are communication ways among the plurality of communication ways have completed the corresponding transmission workload before finishing transmitting the file to be transmitted, transmit file contents, which have not been transmitted, of the file to be transmitted in parallel by using the communication ways that have completed the corresponding transmission workload.

17. The terminal device of claim 15, wherein the plurality of communication ways comprise a first communication way and a second communication way; there are two starting position points, which comprise a file header of the file to be transmitted and an end of the file to be transmitted; the first communication way corresponds to the file header, and the second communication way corresponds to the end of the file; the processor is further caused to:
perform a parallel transmission of transmitting the file contents of the file to be transmitted to the receiving device, by controlling the first communication way to start from the file header, and controlling the second communication way to start from the end of the file to be transmitted.

18. A non-transitory computer-readable storage medium of a terminal device having stored computer program, which when executed by a processor, causes the processor to perform a method for transmitting file, the method comprising:
acquiring a plurality of communication ways;
transmitting file contents of a file to be transmitted to a receiving device in parallel, by using the plurality of communication ways.

19. The non-transitory computer-readable storage of claim 18, wherein acquiring the plurality of communication ways comprises:
acquiring communication ways that are available to perform file transmissions with the receiving device;
determining the plurality of communication ways from the communication ways that are available to perform the file transmissions with the receiving device.

20. The non-transitory computer-readable storage of claim 19, wherein determining the plurality of communication ways from the communication ways that are available to perform the file transmissions with the receiving device comprises:
acquiring file size of the file to be transmitted, and determining the plurality of communication ways from the communication ways that are available to perform the file transmissions with the receiving device, according to the file size; or
acquiring the file size and a file number of the file to be transmitted, and determining the plurality of communication ways from the communication ways that are available to perform the file transmissions with the receiving device, according to the file size and the file number; or
acquiring a transmission speed and a transmission stability of each of the communication ways that are available to perform the file transmissions with the receiving device, and determining the plurality of communication ways from the communication ways that are available to perform the file transmissions with the receiving device, according to the transmission speed and the transmission stability.

21. The non-transitory computer-readable storage of claim 19, before determining the plurality of communication ways from the communication ways that are available to perform the file transmissions with the receiving device, further comprising:
acquiring a usage status of each communication way applied in a transmitting device, among the communication ways that are available to perform the file transmissions with the receiving device;
filtering the communication ways that are available to perform the file transmissions with the receiving device, according to the usage status of the each communication way, and performing an operation of determining the plurality of communication ways from the communication ways that are available to perform the file transmissions with the receiving device, based on remaining communication ways after filtering.

22. The non-transitory computer-readable storage of claim 18, wherein transmitting the file contents of the file to be transmitted to the receiving device in parallel, by using the plurality of communication ways comprises:
determining one or more starting position points in the file to be transmitted, and determining a starting position point corresponding to each communication way of the plurality of communication ways;
controlling each communication way of the plurality of communication ways, starting from a corresponding starting position point, to transmit the file contents of the file to be transmitted to the receiving device in parallel.

23. The non-transitory computer-readable storage of claim 22, wherein the plurality of communication ways comprise a first communication way and a second communication way; there are two starting position points, which comprise a file header of the file to be transmitted and an end of the file to be transmitted; the first communication way corresponds to the file header, and the second communication way corresponds to the end of the file; wherein controlling the each communication way of the plurality of communication ways, starting from the corresponding starting position point, to transmit the file contents of the file to be transmitted to the receiving device in parallel comprises:
performing a parallel transmission of transmitting the file contents of the file to be transmitted to the receiving device, by controlling the first communication way to start from the file header, and controlling the second communication way to start from the end of the file to be transmitted.
